(19) United States
(12) Patent Application Publication
(10) Pub. No.: US 2003/0014296 A1
(43) Pub. Date: Jan. 16, 2003

(54) Community management/communication interface

(76) Inventor: Robert K. Meine, Nampa, ID (US)

Correspondence Address: HEWLETT-PACKARD COMPANY, Intellectual Property Administration, P.O. Box 272400, Fort Collins, CO, 80527-2400, US

(21) Appl. No.: 09/902,393

(22) Filed: Jul. 10, 2001

(51) Int. Cl. G06F 17/60

(52) U.S. Cl. 705/9

(57) ABSTRACT

A community interface is provided that is invocable by instructions executable by a processor based device useable by a community of users. In one embodiment, the executable instructions include code for registering the community members with the device (wherein registering a member includes storing identifying information relating to the member), code for querying a user for stored identifying information, code for receiving information relating to at least one community member, and code for providing information on a display panel of the processor based device, wherein at least a portion of the information provided is a subset of an array of information comprised of a plurality of subsets, wherein each subset is associated with a particular member of the community, and wherein the subset provided depends upon the identifying information provided by the user.

### TECHNICAL FIELD

This application relates in general to information displays, and in one aspect to a system and method for providing a community management/communication interface.

### BACKGROUND

Families with several children (as well as other community groups) have difficulty in keeping track of where specific individuals are located and when they will be finished at that location. For example, parents could be working, attending various meetings, while the children could be at school, school events, sports, scouting, religious activities, etc.

Some families attempt to use a calendar that is mounted in a convenient location upon which the family members mark information. The family members would quickly fill up the calendar squares with names, locations, times, and phone numbers. The information on the calendar becomes jumbled as multiple members attempt to write information in the same squares. Also changes to the calendar result in more confusion, as items are crossed out and written in margins.

One solution is to have multiple calendars, one for each family member. However, this would require a great deal of space, and for larger families, would be impractical. Another solution is to use a PC computer to track the family schedule. However, this is problematic because other family members may be using the computer, e.g. doing homework, playing games, or surfing the Internet, and maintaining multiple computers can be expensive. Also computers tend to be away from convenient locations of the house, e.g. they are in home offices or bedrooms, and not high traffic areas such as kitchens or family rooms. Another solution is to use Post-It Notes™ or sticky sheets to write down the appointment information. However, these notes can be lost or covered over by other notes.

Therefore, there is a need for a system and method to track the appointments for a family (or other community group).

### SUMMARY OF THE INVENTION

The present invention is directed to a system and method for providing a community interface. In at least one embodiment, the community interface is invocable by instructions executable by a processor based device useable by a community of users. The executable instructions include code for registering a plurality of the community members with the device (wherein registering a member includes storing identifying information relating to the member), code for querying a user for stored identifying information, code for receiving information relating to at least one community member, and code for providing information on a display panel of the processor based device, wherein at least a portion of the information provided is a subset of an array of information comprised of a plurality of subsets, wherein each subset is associated with a particular member of the community, and wherein the subset provided on the display panel depends upon the identifying information provided by the user.

### BRIEF DESCRIPTION OF THE DRAWING

FIG. 1 depicts a kitchen arrangement using the present invention;

FIG. 2 depicts a stand-alone embodiment of a processor based device in accordance with the present invention;

FIG. 3 depicts a block diagram of a processor based system which is adapted to work with the present invention;

FIG. 4 depicts a first embodiment of a user interface in accordance with the present invention;

FIG. 5 depicts a second embodiment of a user interface in accordance with the present invention;

FIG. 6 depicts a third embodiment of a user interface in accordance with the present invention; and

FIG. 7 depicts an embodiment of a shopping list of a user interface in accordance the present invention.

### DETAILED DESCRIPTION

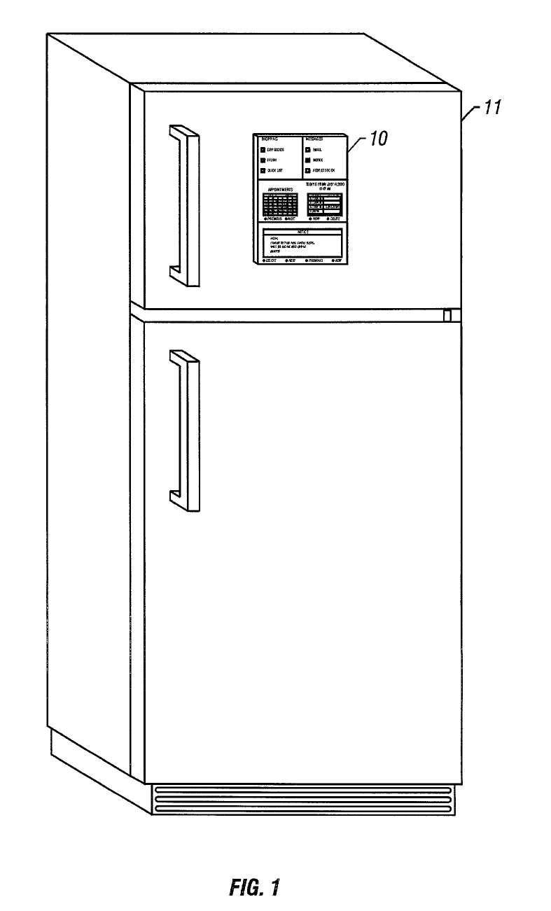

FIG. 1 depicts an exemplary arrangement of an embodiment of the invention. As mentioned, the present invention is directed to a system and method for providing a community interface. The interface or center is preferably located in a high traffic area, e.g., kitchen, family room, copy room. Placing the interface in a high traffic area allows the interface to be accessed by the entire community (e.g., the entire family).

In one embodiment, the interface includes a processor based device that provides a user interface (UI) to the different community (e.g., family) members which, in some embodiments, allows them to enter change, and review the appointment schedules of the different community members, as well as review and respond to messages from the other community members. The schedules can be operated upon in a daily, weekly, monthly, and/or yearly manner. In at least one embodiment, the interface can also track needed grocery or other shopping items. The interface is preferably easy to use so that all members of the community can use it, including children (e.g., four or five year olds). The processor based device preferably provides the UI on a touch screen, which allows the users to readily input and edit the appointments, messages, and other information provided. The interface device could also work with either a touch screen keyboard or touch screen pen with character recognition.

Preferably, the UI allows users to choose from different information sections, e.g., appointment calendar, e-mail, notices, shopping lists, address book, phone book, news information, stock information, etc. The user can then make a desired choice and provide or review his or her desired information. For example, a user can select e-mail and review his/her e-mails or draft and send a new e-mail. Also, a user can select notices and review existing notices.

In at least one embodiment, the interface provides to any particular user only a portion (i.e., a subset) of the information provided to and/or accessible to the interface, and the particular information provided to a user depends upon the identifying information provided by the user (e.g., a user name, password) to the interface. For example, after a user identifies his/herself through the provision of identifying information to the interface, the interface may provide to the user a general appointments calendar providing the appointments of all community members, a messages portion providing only messages sent to or by the user, and a stock information service subscribed to by the user. On the other hand, the interface provides to a second user, after identifying his/herself via the provision of identifying information, the general appointments calendar, a messages portion providing only messages sent to or by the second user, and a news information service subscribed to by the second user. In at least one embodiment, the information used to identify a particular user is determined, selected, assigned, etc., during a registration process.

In FIG. 1, community interface device 10 is located on refrigerator 11 which would be located in the kitchen of a family dwelling. Note that the location and size of the interface device 10 is by way of example only, as the device could be larger or smaller, and placed in a different location on the refrigerator. Preferably, the size of interface device 10 is such that the device may be easily transported around the dwelling. Interface device 10 may be attached to other locations within the kitchen, e.g., a different appliance, a wall, a piece of furniture, etc. Moreover, interface device 10 may be located in a different room within the dwelling altogether, e.g. the family room or living room. Preferably, device 10 is located in a high traffic area, e.g. kitchen or family room, where the device may be accessed by the entire family.

Interface device 10 may be secured to refrigerator 11 (or other appliance, wall, piece of furniture, etc.) through anyone of the variety of known means for securing an object to a wall, appliance, etc., to include a mounting cradle, magnets, adhesives, screws, and/or the like. In at least one embodiment, device 10 is incorporated into the appliance, wall, etc.

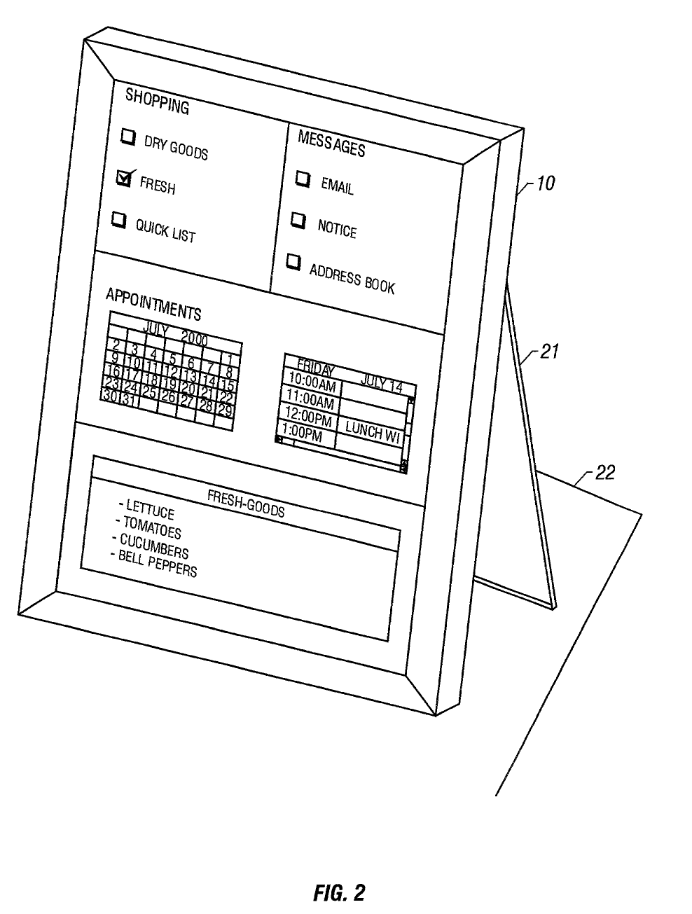

Furthermore, rather than being attached to or incorporated in an appliance, wall, etc., community interface device 10 may be a stand alone device. For instance, FIG. 2 depicts the interface device 10 located on a horizontal surface 22, e.g., a desk, bench, table, counter top, or other flat surface. This embodiment includes at least one leg 21 that supports device 10 in a useable position. Leg 21 could be connected to device 10 via a hinge, which would allow adjustment of the angle of the device with respect to surface 22. The configuration of device 10 depicted in FIG. 2 is by way of example only as other configurations would work, e.g., a separate stand into which the interface device fits.

Note that the invention has been described in terms of use in a house for a family, however the inventive device may be used in different locations and with different people, for example in an office with co-workers or other situations where a communally-accessible appointment calendar, message board, address book, and/or the like would be desired.

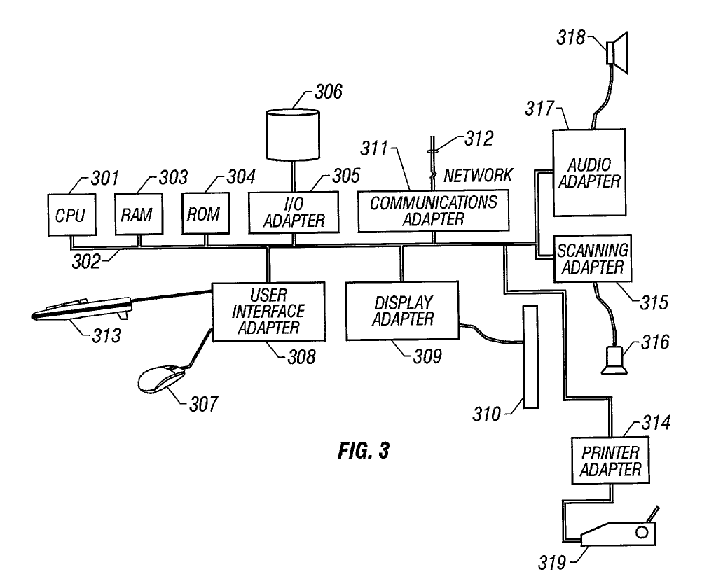

FIG. 3 depicts a block diagram of device 10, which includes a central processing unit (CPU) 301 that is coupled to system bus 302. CPU 301 may be any general purpose CPU, such as an HPTM PA-8500 or Intel Pentium™ processor. However, the present invention is not restricted by the architecture of CPU 301 as long as CPU 301 supports the inventive operations as described herein. Bus 302 is coupled to random access memory (RAM) 303, which may be SRAM, DRAM, or SDRAM, including non-volatile RAM. ROM 304 is also coupled to bus 302, which may be PROM, EPROM, or EEPROM. RAM 303 and ROM 304 hold user and system data and programs as is well known in the art. Bus 302 is also coupled to display card 309 and user interface card 308. User interface card 308 couples user input devices, such as keyboard 313 and pointing device 307, to device 10. The pointing device and/or the keyboard may be the touch sensitive display screen of device 10 or additional devices that are connected to device 10. Display card 309 is driven by CPU 301 to control display 310 of device 10. The display screen 310 could be formed from a liquid crystal display screen.

Optionally, bus 302 may also be coupled to input/output (I/O) controller card 305 and/or communications adapter card 311. I/O card 305 connects to storage device(s) 306, such as one or more of a hard drive, CD drive, floppy disk drive, tape drive, flash memory device, etc., to the computer system. Note that elements 305 and 306 are optional and not needed if the non-volatile memory portions are large enough. If e-mail is to be used, then elements 311 and 312 are included.

Communications card 311 is adapted to communicatively couple device 10 to a network 312, which may be one or more of a telephone network, a local-area network (LAN), a metropolitan-area network (MAN), a wide-area (WAN) network, an Ethernet network, a fibre channel network, an Internet network, and the like. Device 10 may be communicatively coupled to network 312 via a wired or wireless connection, to include a hard wire connection, a telephone line connection, a radio connection, e.g. via two 900 MHz transceivers (one connected to the network and the other connected to device 10) or combinations thereof. Moreover, communications adapter 311 may include more than one means to communicatively couple device 10 to network 312. For example, device 10 may include a first network port (e.g., an RJ 45 port) for directly coupling device 10 to a network device (e.g., the family PC in some instances or some other network node or hub), as well as a second network port for obtaining a dial-up connection to the network.

In addition, device 10 may include an infrared port, which may be located adjacent to the display screen and readily accessible to the user. Preferably, the infrared port enables a user to communicatively couple device 10 to other devices, e g., to download information. For example, a user could connect a personal data assistant (PDA) and download the appointment schedule. Other port types could be used instead of or along with the infrared port, e.g. USB port(s), serial port(s), and/or parallel port(s). In at least one embodiment, device 10 maybe communicatively coupled to network 312 via the infrared port.

In addition, bus 302 may be coupled to scanning adapter card 315. The scanning adapter card 315 allows for connection to a scanning device 316, such as a bar code scanner or other optical scanning device. Scanning device 316 may be included as part of device 10 or may be an auxiliary device connected thereto. Furthermore, bus 302 may be connected to audio adapter card 317. Audio adapter card 317 allows for connection to an audio device (e.g., microphone/speaker 318). Microphone/speaker 318 may be a microphone, a speaker, or some combination thereof. Like scanning device 316, microphone/speaker 318 may be included as part of device 10 or may be an auxiliary device coupled thereto.

Moreover, inventive device 10 may also include a printer adapter card 314. Printer adapter card 314 allows for connection to printer 319 from which user selected information may be printed.

The exterior housing of device 10 (not shown in FIG. 3) is preferably made from durable material (e.g., plastic). Moreover, most preferably, the exterior housing protects device 10 from heat and moisture, as well as other harmful elements that may be present in high use areas (e.g., food, drink).

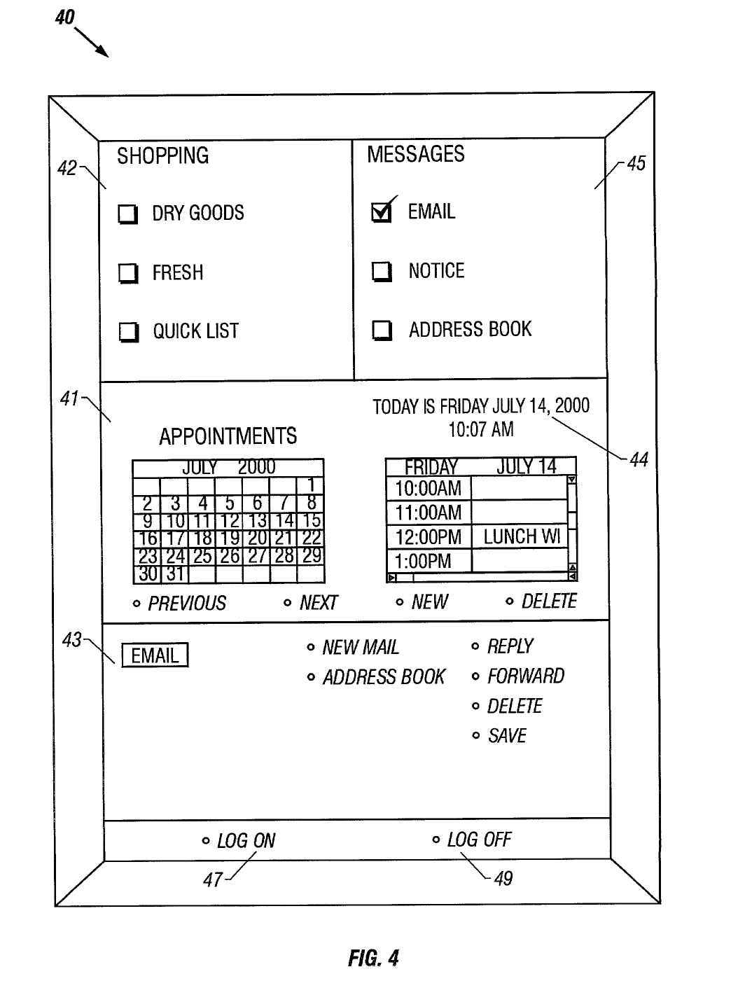

FIG. 4 depicts an exemplary embodiment of user interface (UI) 40 (also referred to as community interface 40) that interface device 10 provides to a user(s). User interface 40 may be enabled on device 10 in a number of different ways. For instance, in at least one embodiment, a UI computer program capable of invoking UI 40, wherein a program is defined as any set of computer executable instructions, already resides within the memory (e.g., ROM 304) of device 10 when device 10 is purchased (e.g, the UI program is already loaded onto or embedded in a memory device). In other embodiments, the UI program may be downloaded from storage devices 306. In still other embodiments, the UI program may be downloaded from a network (e.g., the Internet) onto the memory of device 10. In such instances, preferably, a user may customize the interface through interaction with a website and then download the customized interface onto device 10. In yet other embodiments, the interface program may be stored on a memory module (e.g., flash ROM module or memory cards) that may be loaded onto device 10 (e.g., through an external expansion slot). In at least some of these embodiments, different versions of the user interface (e.g., an executive pack vs. a family pack) reside on different memory modules. In such instances, the user may select the interface most suiting the user's needs and then load the particular memory module on which the desired interface is stored onto device 10.

UI 40 includes at least one display region that provides information relating to at least one member of the community (e.g., one member of the family). For instance, as shown in FIG. 4, UI 40 may include appointment calendar section 41. In at least one embodiment, this section allows the user to review his/her schedule, as well as that of the various family members, for various days and times. The schedules can be operated upon in a daily, weekly, monthly, and/or yearly manner. Preferably different months can be selected by using the previous and next buttons, which preferably are touch screen controls. Selecting a particular day on the calendar will, in at least some embodiments, result in the appointments for that day being displayed, preferably hour by hour. Selecting a particular appointment entry, as well as selecting a new entry, will cause a touch screen keyboard to appear, which can be used by the user to form/edit entries. Note that the appointment calendar section, as well as other sections of the user interface, may be edited via a character recognizer instead of or in addition to the touch screen keyboard. The character recognizer would allow a user to input text and commands via a stylus and/or finger. The user would write the desired letters into the character recognizer portion of the user interface. The device would then convert the written information into computer useable data.

Through the various possible ports of device 10 discussed earlier, e.g., infrared ports, network ports, etc., the appointment calendar can be synchronized with an appointment calendar residing on another device (e.g., a computer, a PDA, etc.) or downloaded to or from another device. In some embodiments, the appointment schedule may be printed out for inclusion with an appointment book, e.g., dayrunner. Also in some embodiments, the user may e-mail the schedule to a work location or to another person, e.g., administrative assistant.

Preferably, appointment calendar section 41 also includes time/date indicator 44. Instead of or in addition to time/date indicator 44, the present date may be highlighted on the appointment calendar and/or the present hour may be highlighted in the daily appointments section. In some embodiments of UI 40, selecting (e.g., through tapping on the touch screen) time/date indicator 44 results in the appearance of a clock/date portion (not shown) whereby the time and date may be set. Preferably, the clock/date portion also includes a timer(s) and/or an alarm set portion. If a timer is activated, preferably the time elapsed appears within UI 40 after the clock/date portion has been deselected. Likewise, if an alarm is set, preferably an alarm indicator denoting that an alarm has been set appears within UI 40 after the clock/date portion has been deselected. In some embodiments, the alarm may be deactivated by selecting the alarm set indicator.

UI 40 may also include a messages portion 45. Messages portion 45 preferably allows a user to review, edit, and/or generate several different categories of messages (e.g., notices, e-mail messages, etc.), as well as to review, edit, and/or generate an entry in an address book and/or a phone book. In at least some embodiments, messages portion 45 includes listings of different categories of messages, as well as a listing for an address book. Selection of a particular listing results in the displaying of an interface portion relating to the selected listing. In the embodiment of FIG. 4, the related interface portion appears in section 43 of interface 40. Also in the embodiment of FIG. 4, once a listing is selected, a check mark or other indicator appears next to the selected listing (e.g., the check mark next to “EMAIL” in FIG. 4).

As shown in FIG. 4, interface 40 may include an e-mail portion (located within section 43 of FIG. 4), which provides e-mails to the user. In at least one embodiment, device 10 communicates with a data network (e.g., the Internet) and/or a network service provider to obtain the e-mails. The user can perform various actions on the e-mails through controls or buttons, which preferably are touch screen controls. Selecting actions such as reply, forward or new mail, in some instances, will cause a touch screen keyboard to appear, which can be used by the user to generate the various responses. As mentioned earlier, in some embodiments, e-mail responses can be generated through a character recognizer instead of or in addition to the touch screen keyboard. As shown in FIG. 4, the e-mail portion may include a link to an address book (to be described in more detail below), which may be used to retrieve e-mail addresses of potential recipients.

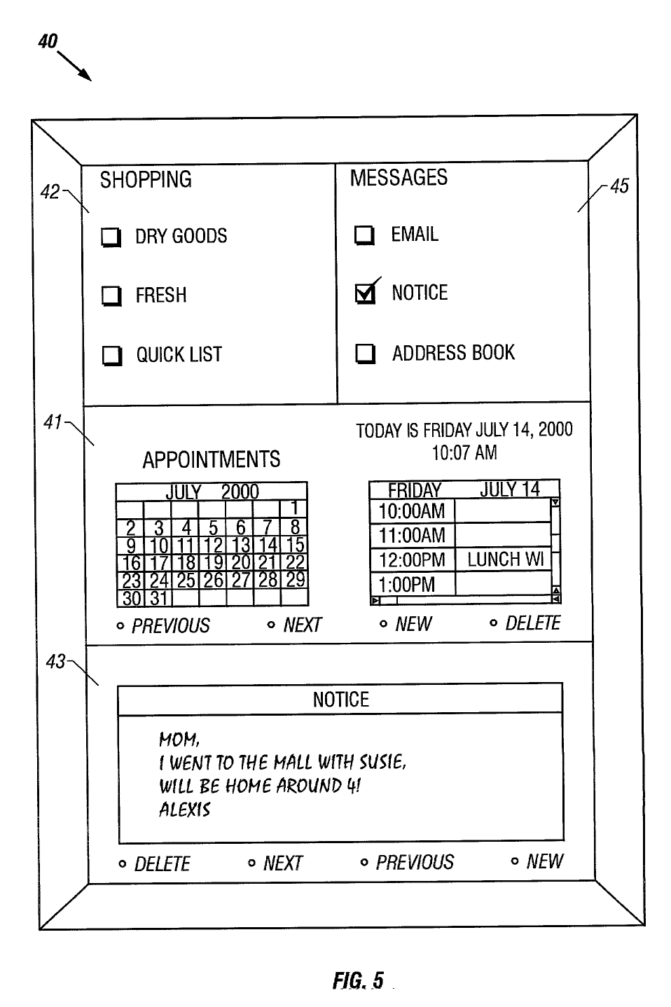

As illustrated in FIG. 5, interface 40 may include a notice portion (located within section 43 of FIG. 5), which allows the user to review, edit, and/or generate messages that are preferably viewable by all users (unlike the e-mail portion whereby preferably the messages may only be viewed by the sender(s) and/or the recipient(s)). In the embodiment of FIG. 5, the selection of the “NOTICE” listing in messages portion 45 resulted in the appearance of the notice portion in section 43, as well as the appearance of a check mark next to the “NOTICE” listing. The user can perform various actions on the notice messages according to controls or buttons, which preferably are touch screen controls. Selection of touch screen controls such as delete, next, previous, new, etc., may cause a touch screen keyboard to appear, which can be used to review, generate, edit or delete the posted messages. As mentioned earlier, in some embodiments, notice messages can be generated through a character recognizer instead of or in addition to the touch screen keyboard. The notice message may take on many forms. For example, in some embodiments, the message comprises text and a simple square boundary. In other embodiments, a notice message, once posted, appears as a yellow square with text inside. In still other embodiments, the notice appears as an index card. In yet other embodiments, the message comprises only text.

As mentioned, messages portion 45 may also include a listing for an address book. In one embodiment, upon the selection of the address book listing, an address book portion appears somewhere in interface 40. The address book portion may provide information relating to names, addresses, etc., in the form of entries that may be reviewed, edited, and/or generated by a user. The address book portion may provide physical addresses, as well as electronic mail addresses. In addition, the address book may include phone numbers. In some embodiments, selection of a phone number in the address book results in the dialing of the phone number. In at least one of these embodiments, the user and the dialed party may verbally communicate with each other using microphone/speaker 318. Through the various possible ports of device 10 discussed earlier, e.g., infrared ports, network ports, etc., the address book can be synchronized with an address book located on another device (e.g., a computer, a PDA, etc.). and/or downloaded to or from another device.

UI 40 preferably includes shopping list portion 42. Shopping list portion 42 may have several configurations. For instance, shopping list portion 42 may comprise a single shopping list containing item entries that may be reviewed, edited, and/or generated by a user. In other embodiments, a user is able to create a plurality of lists each relating to a different category of food and/or other shopping items. For example, as shown in FIG. 4, a user may create one list for dry goods and related items that the user titles “DRY GOODS” and a second list for fresh food items entitled “FRESH”. The user may also create a third list which the user titles “QUICK LIST” for those items that are used the most by family members. In some embodiments of interface 40, at least some shopping lists have been pre-programmed into the UI.

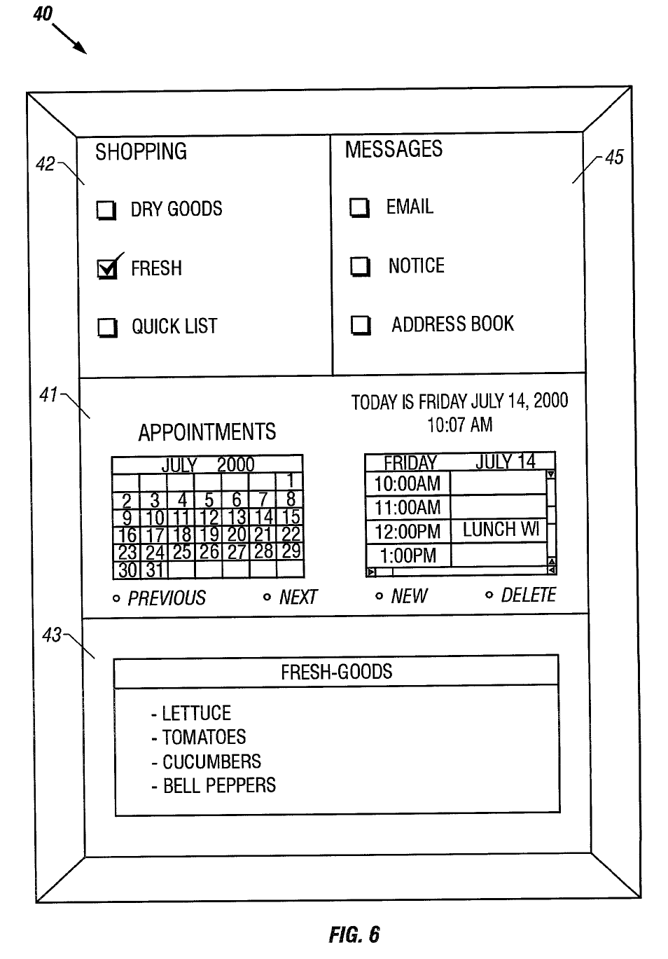

In embodiments of shopping list portion 42 where more than one list has been established, preferably, only the title of the list appears in shopping list portion 42 (as is the case in FIGS. 4, 5, and 6). In such instances, selection of a particular list title by a user results in the display of the selected list (e.g., in FIG. 6, the “FRESH” shopping list appears in section 43). Similar to the situations described earlier, in the embodiment of FIG. 6, once a particular shopping list is selected, a check mark or other indicator appears next to the selected list (e.g., the check mark next to “FRESH” in FIG. 6). Selection of an item entry within the list will cause a touch screen keyboard to appear, which can be used to generate/edit entries. Note that an entry may be edited or generated via a character recognizer instead of or in addition to the touch screen keyboard. An item entry may include such things as a description of the item, the quantity desired, and/or the quantity presently in-house (i.e., in-stock).

In a preferred embodiment, item entries may also be generated or edited through the use of scanning device 316. For example, a bar code located on an item's packaging or the item itself (e.g., the UPC code) may be scanned using scanning device 316. The scanned information is then compared to the information contained in the selected shopping list by the interface program. The scanned information may also be compared to that of other shopping lists. If the item is not presently on the selected list, in a preferred embodiment, the user is asked if the user would like to add the item to the selected list. An affirmative response preferably results in the appearance of the scanned information on the selected shopping list, as well as a touch screen keyboard that can be used to edit the entry (e.g., edit the item description, the quantity desired, and/or the quantity in stock). Note that an entry may be edited via a character recognizer instead of or in addition to the touch screen keyboard. If the item is presently on the selected list, the touch screen keyboard and/or the character recognizer may still appear, thus allowing the user to edit the entry in some manner or to form new entries. In some embodiments, the item entry may be autonomously edited as a result of the scanning. For example, the quantity in stock number may be increased. In those instances where the scanned information is compared to another or all of the shopping lists, the user may be informed that the item appears on a shopping list other than that which was selected. Preferably, the user is then asked whether the user would like the item moved to the selected shopping list or remain in its present location

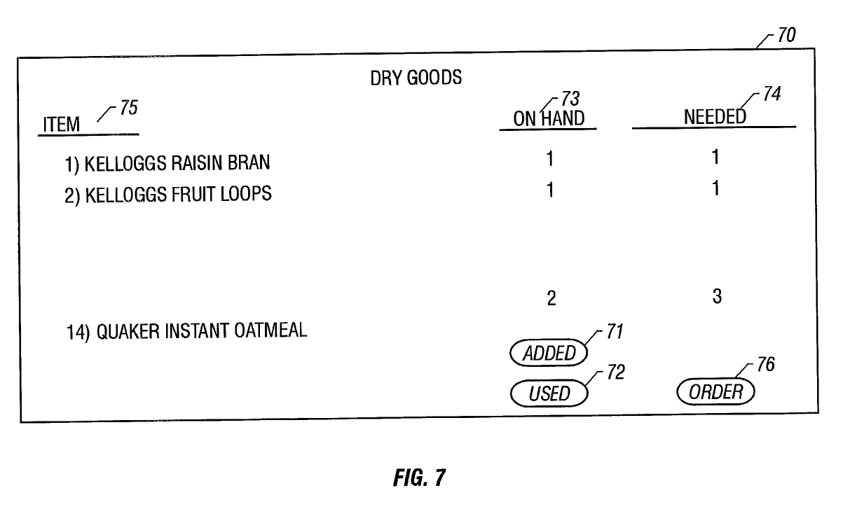

Shopping list portion 42 may be used to keep track of household inventory. To illustrate, a family member has just finished a box of cereal (e.g., Kellogg's Raisin Bran™) and wants to notify the other family members of such so that a new box is purchased on the next shopping trip. Accordingly, the family member selects the DRY GOODS title located in shopping portion 42. The selection of the DRY GOODS title results in the appearance of the DRY GOODS list somewhere within interface 40. An exemplary embodiment of the DRY GOODS list is depicted in FIG. 7. List 70 of FIG. 7 includes an item description column 75, an on hand column 73, and a needed column 74. Item description column 75 provides a brief description (e.g., the name) of the particular shopping item included in the list. On hand column 73 indicates the present inventory of the particular items on hand. Furthermore, needed column 74 provides the preferred maximum on hand inventory of each item on the list. List 70 also includes a “used” button 72, an “added” button 71, and an “order” button 76.

If the item the above mentioned family member wants purchased is included in list 70, the family member may highlight the item by selecting the item entry (e.g., by touching the entry) or by scanning the item (e.g., scanning the UPC bar code). If the item is not presently on the list, the item may be added to the list via one of the methods discussed earlier.

After highlighting the item, the family member selects used button 72. Used button 72 is a touch screen control that signals that one quantity of the highlighted item has been used and therefore should be deleted from inventory. Once used button 72 is selected, the number located in column 73 pertaining to the highlighted item (in this example, the number pertaining to Kellogg's Raisin Bran™) is decreased by one.

If the item is later purchased on a subsequent shopping trip, a family may signal that the item has been restocked by selecting the dry goods list, highlighting the item (e.g., selecting the item or scanning), and selecting added button 71. Added button 71 is a touch screen control that signals that the highlighted item should be added to inventory. Once added button 71 is selected, the number located in column 73 pertaining to the highlighted item (in this instance, the number pertaining to Kellogg's Raisin Bran™) is increased by one.

A shopping list may be printed via an attached printer and used to purchase the requested items. If the device does not have an attached printer, the list may be sent (e.g., via e-mail) to a computer that does have an attached printer or to a PDA that may be carried to the grocery store. Moreover, the list(s) may be sent (e.g., via e-mail) to a grocer or an on-line grocery service who may then prepare the groceries for pick-up or who may deliver the items to the user's house or other selected location(s). In at least one embodiment, a user sends the list(s) to a grocer, etc., by selecting order button 76. Moreover, in embodiments where the shopping list includes a needed column and an on hand column, the family member or grocer filling the order may do so by providing enough of a particular item such that the quantity on hand would equal the quantity needed.

UI 40 may also include a news portion (not shown), which provides the user with news information from user-selected sources. This news information may be downloaded from a provider through a network (e.g., the Internet). Instead of or in addition to the news portion, the UI may include a stock data section (also not shown), which provides the user with stock information. The stock information may include general stock data, which can be streaming from a service, or the current prices of particular stocks selected by the user and stored in the user profile. The user-selected sources, stocks, etc., may be stored in the user profile mentioned earlier so that the user only receives news or stock information relating to the particular user's selected sources, stocks, etc.

In at least some embodiments of interface 40, the various portions of the UI may autonomously interact with each other. For example, the appointments calendar portion and the messages portion may interact to place an e-mail message in a user's box or to post a notice message reminding the particular user of an upcoming appointment. Also, the messages portion and news portion can interact to place news stories that might be of interest to a particular user into the user's mailbox. As another example, the messages portion and the shopping portion may interact to post a notice reminding all users that it has been x days since a perishable item (e.g., milk) has been purchased.

Note that other embodiments are possible, for example a television portion could be added which would have channel controls, volume controls, etc. Thus, the UI could comprise more or fewer sections, as well as different components for each section. Furthermore, the UI could comprise sections having different functions and/or providing different information.

Also note that the appearance of the UI is by way of example only as other UI's could be used to perform in a similar manner. For example, UI 40 may comprise a group of icons, which upon the selection of a particular icon, an interactive portion relating to the selected icon appears.

In at least some embodiments of device 10, device 10 is configured such that display 310 displays something other than UI 40 if a user does not interact with UI 40 for a certain period of time. Moreover, in at least some of these embodiments, device 10 also powers down after a certain period of inactivity. In at least one embodiment, display 310 goes blank after certain period of inactivity. In other embodiments, display 310 displays a screen saver (e.g., a moving object of some sort) after a similar period of inactivity. In still other embodiments, display 10 displays an image downloaded to the device, e.g., through one of the ports of device 10, after a certain period of inactivity. Such an image may be a digital image of the family, a favorite scene, a favorite artwork, a favorite actor(tress), etc. Thus, device 10 may give the appearance of a digital picture frame when not in use. In other embodiments, the display may comprise a loop of different images, each image being displayed for a particular amount of time. For example, an image of the family dog may be displayed for x seconds, then a picture of a family member may be displayed for x seconds, then the image of the family dog appears again for x seconds. The transition between images may include transition effects such as wipes, fades, screen melts, pixel flow, etc. In yet other embodiments, the images (e.g., advertisements) may be pre-programmed into the UI. In the above described embodiments, the device may be powered up, the UI may reappear, etc., upon the tapping of the touch screen by a user. The period of time before the display changes, the device powers down, etc., may be configured by a user.

Although previously only a single community interface device has been discussed, multiple community interfaces of the present invention may be present in the same dwelling, office, location, etc. Moreover, these devices may be connected together to form a network. The network connections may include an infrared connection, a hard wire connection, a telephone connection, and/or a radio connection (e.g. via 900 MHz transceivers as discussed earlier). In such embodiments, each device within the network may have its own identifier, email address, etc. (e.g., a family communication device in a living room may have the identifier Bob's_Home_Device1@home.com, whereas a device in the kitchen has the identifier Bob's_Home_Device2@home.com). Moreover, such a network is not limited to community interface systems, but may include other processor based devices that are capable of being networked, such as PCs or PDAs. Through these network connections, the various devices may be synchronized with each other. In at least one embodiment of such a network, the networked devices may act as an intercom system for the dwelling.

Moreover, in at least one embodiment, rather than provide a particular user the entire array of information provided to and/or accessible to interface 40, for at least one display region, UI 40 instead only provides to any one particular user a subset of the available information. For example, with respect to messages portion 45, in one embodiment different users (e.g., different members of the family) would be provided with their particular e-mails, but not those of the other users. As another example, in one embodiment, different users are provided with the different news or other information services they subscribe to (e.g., stock information), but not those subscribed to by the other users.

In at least one embodiment, the particular subset of information provided to a user from among the possible subsets of information depends upon identifying information provided by the user to interface 40. For example, in one embodiment, the members of the community of users of device 10 (e.g., the family members) are registered with device 10. In at least one embodiment, this is accomplished as part of an initiation routine. In another embodiment, an initial password and login name are provided to the purchaser of the device through which a user may log in to the device and register his/herself, as well as other members of the community of users.

In at least one embodiment, as part of the registration, identifying information for each user is provided, assigned, chosen, and/or determined. In one embodiment, the identifying information includes a log-in name and/or additional qualifying information such as a password. In an alternative embodiment (e.g., for ease of use for children), the identifying information consists simply of the user's name. In at least one embodiment, the identifying information is then stored by device 10 (either at device 10 or a storage medium communicatively coupled thereto). In a preferred embodiment, in addition to the identifying information, device 10 stores/maintains a profile of each of the different users to include any user defined configurations, preferences, subscriptions (e.g., news information service, stock information service), etc.

Furthermore, in at least one embodiment, sometime after registration, a user logs in with device 10. In various embodiments, a user logs in by providing at least some of the stored identifying information discussed above. In at least some of these embodiments, a particular user logs in by selecting log on button 47 (which preferably is a touch screen control). In at least one embodiment, upon selecting button 47, a log in prompt appears, as well as a touch screen keyboard, which can be used to enter a log in name and/or additional qualifying information. In another embodiment, a user logs in by selecting the user's name from among a presented table of registered users.

After acceptable identifying information is provided (e.g., a user name is selected and/or a password is provided), for at least one display region, the user is provided with the information associated with the identified user (e.g., the e-mail sent to or by the identified user, the new service subscribed to by the identified user, etc.). Moreover, in at least one embodiment, once logged in, a user may register other users with device 10.

In at least one embodiment, when finished interacting with device 10, a user may log out by selecting the log out button 49 and/or by turning the display screen off.

For at least one of the above described display regions, the information provided to a particular user may include information relating to more than one member of the community of users (e.g., an appointment calendar, shopping list, a notice). Moreover, such information relating to more than one community member may include a first quantum of information relating to a member of said community and a second quantum of information relating to another member of said community (e.g., an appointment calendar where one appointment entry relates to one community member, while another appointment entry relates to another family member).

What is claimed is:

1. A computer readable medium including instructions executable by a processor based device useable by a community of users, said computer readable medium comprising:
code for registering a plurality of members of said community with said device, wherein registering a member includes storing identifying information relating to the member;
code for querying a user for stored identifying information;
code for receiving information relating to at least one member of said community of users; and
code for providing information on a display panel of said processor based device, wherein at least a portion of said information provided is a subset of an array of information comprised of a plurality of subsets, wherein each subset is associated with a particular member of said community, and wherein said subset provided depends upon identifying information provided by said user.

2. The computer readable medium of claim 1 wherein at least a portion of said information provided relates to more than one member of said community.

3. The computer readable medium of claim 2 wherein said information relating to more than one member of said community includes a first quantum of information relating to a member of said community and a second quantum of information relating to another member of said community.

4. The computer readable medium of claim 1 wherein said information provided on said display panel includes appointment information.

5. The computer readable medium of claim 1 wherein said subset includes messages information.

6. The computer readable medium of claim 5 wherein said messages information includes electronic mail.

7. The computer readable medium of claim 1 wherein said information provided on said display panel includes shopping information.

8. The computer readable medium of claim 1 wherein said code for receiving information includes code for receiving information from a scanning device.

9. The computer readable medium of claim 1 wherein said processor based device includes a coupling mechanism for securing the processor based device to an appliance.

10. A community interface system comprising:
portable processor based device including
display panel,
means for registering with said device a plurality of members of a community of users of said device, wherein registering a member includes storing identifying information relating to the member,
means for querying a user for stored identifying information,
means for receiving information relating to at least one member of said community of users, and
means for providing information on said display panel of said portable processor based device, wherein at least a portion of said information provided is a subset of an array of information comprised of a plurality of subsets, wherein each subset is associated with a particular member of said community, and wherein said subset provided depends upon identifying information provided by said user.

11. The system of claim 10 wherein at least a portion of said information provided relates to more than one member of said community.

12. The system of claim 11 wherein said information relating to more than one member of said community includes a first quantum of information relating to a member of said community and a second quantum of information relating to another member of said community.

13. The system of claim 10 wherein said portable processor based device further comprises means for accessing executable code stored on a memory module, said executable code facilitating said receiving of said information and said providing of said information.

14. The system of claim 10 wherein said system includes a scanning device.

15. The system of claim 10 wherein said system is operable to be communicatively coupled to a second processor based device so as to form a network.

16. The system of 10 wherein said device includes means for coupling to an appliance.

17. The system of claim 10 wherein said device includes means for outputting audio signals to an audio device.

18. A method for providing a community interface comprising:
registering with a processor based device a plurality of members of a community of users of said device, wherein registering a member includes storing identifying information relating to the member;
querying a user for stored identifying information;
receiving information relating to at least one member of said community of users of said processor based device; and
providing information on a display panel of said processor based device, wherein at least a portion of said information provided is a subset of an array of information comprised of a plurality of subsets, wherein each subset is associated with a particular member of said community, and wherein said subset provided depends upon identifying information provided by said user.

19. The method of claim 18 wherein at least a portion of said information provided relates to more than one member of said community.

20. The method of claim 18 wherein said receiving information includes receiving information from a scanning device.
